(19) United States
(12) Patent Application Publication
(10) Pub. No.: US 2013/0141355 A1
(43) Pub. Date: Jun. 6, 2013

(54) TOUCH SENSITIVE DISPLAY MODULE AND ELECTRONIC DEVICE USING THE SAME

(71) Applicants: YOU-LI HE, Shenzhen City (CN); JIN-HONG QIN, Shenzhen City (CN); JIAN-FENG FAN, Shenzhen City (CN); ZHI-GANG YANG, Shenzhen City (CN); QING DAI, Shenzhen City (CN); HONG-WEI DONG, Shenzhen City (CN); CHIA-MIN WANG, Tu-Cheng (TW); KUN-CHIH HSIEH, Tu-Cheng (TW)

(72) Inventors: YOU-LI HE, Shenzhen City (CN); JIN-HONG QIN, Shenzhen City (CN); JIAN-FENG FAN, Shenzhen City (CN); ZHI-GANG YANG, Shenzhen City (CN); QING DAI, Shenzhen City (CN); HONG-WEI DONG, Shenzhen City (CN); CHIA-MIN WANG, Tu-Cheng (TW); KUN-CHIH HSIEH, Tu-Cheng (TW)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/570,276

(22) Filed: Aug. 9, 2012

(30) Foreign Application Priority Data
Dec. 2, 2011 (CN) 201110395127.4

(51) Int. Cl. G06F 3/041

(52) U.S. Cl. 345/173

(57) ABSTRACT

An electronic device includes a touch sensitive display module. The touch sensitive display module includes a securing structure to secure a touch panel, a front frame and a display panel together. The securing structure includes an elongated securing member and double-faced adhesive tapes. The securing member includes a sidewall, and an elongated tab and an angled portion protruding from two edges of the sidewall of the securing member. The elongated tab is sandwiched between the display panel and the touch panel. The sidewall of the securing structure is sandwiched between a limiting element of the front frame and the display panel, and the limiting element of the front frame rests on the angled portion. The double-faced adhesive tape adhere the touch panel to the supporting surface of the front frame and the elongated tab, and adhere the elongated tab to the display panel.

### BACKGROUND

1. Technical Field

The present disclosure relates to an electronic device having a touch sensitive display module.

2. Description of Related Art

With the popularization of electronic devices such as tablet computers or electronic readers, providing a thinner, smaller structure but a wider screen for the electronic device is one of important aspects in manufacturing such electronic devices. In order to meet the requirements, the front frame surrounding the screen of the electronic device is usually made to have a narrow width. Usually, a double-faced adhesive tape is used to attach a touch panel onto the front frame of the electronic device. However, the touch panel cannot be firmly affixed to the front frame because the contact area between them is too small. The display panel under the touch panel may move and push the touch panel, which may cause the touch panel to move upward and may affect the appearance of the electronic device.

Therefore, a touch sensitive display module to resolve the problems mentioned above is needed.

### BRIEF DESCRIPTION OF THE DRAWINGS

Many aspects of the embodiments can be better understood with reference to the following drawings. The components in the drawings are not necessarily drawn to scale, the emphasis instead placed upon clearly illustrating the principles of the present disclosure. Moreover, in the drawings, like reference numerals designate corresponding parts throughout the several views.

FIG. 1 is an isometric view of an electronic device according to an embodiment, showing a touch sensitive display module.

FIG. 2 is an exploded view of the touch sensitive display module of FIG. 1, showing a securing member.

FIG. 3 is a cross-sectional view taken along line of the electronic device of FIG. 1.

FIG. 4 is a partial isometric view of the securing member of FIG. 2.

### DETAILED DESCRIPTION

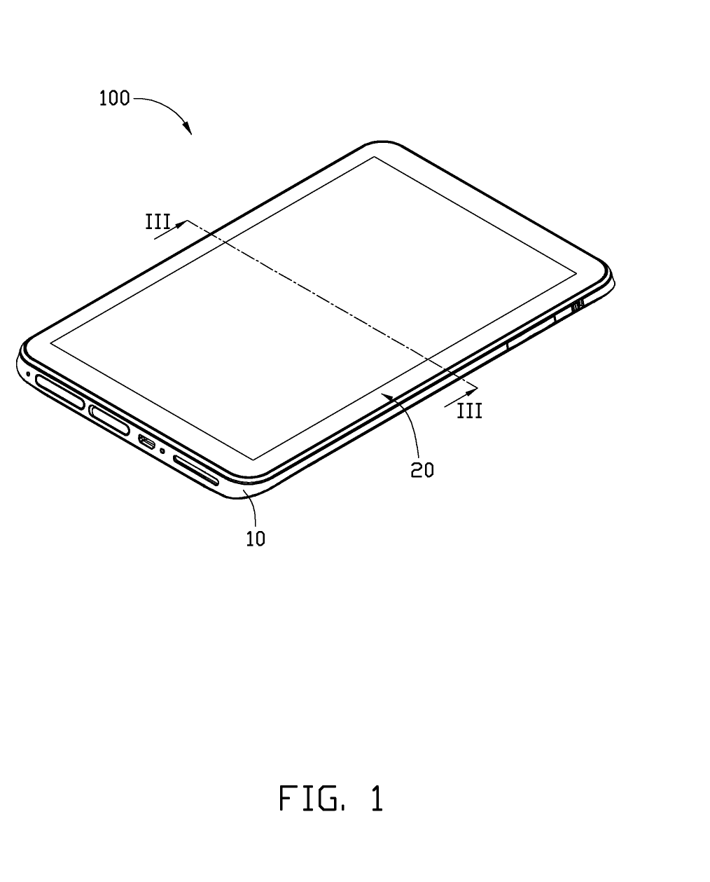

Referring to FIG. 1, an electronic device 100 is disclosed as an exemplary embodiment. The electronic device 100 includes a housing 10 and a touch sensitive display module 20 housed in the housing 10.

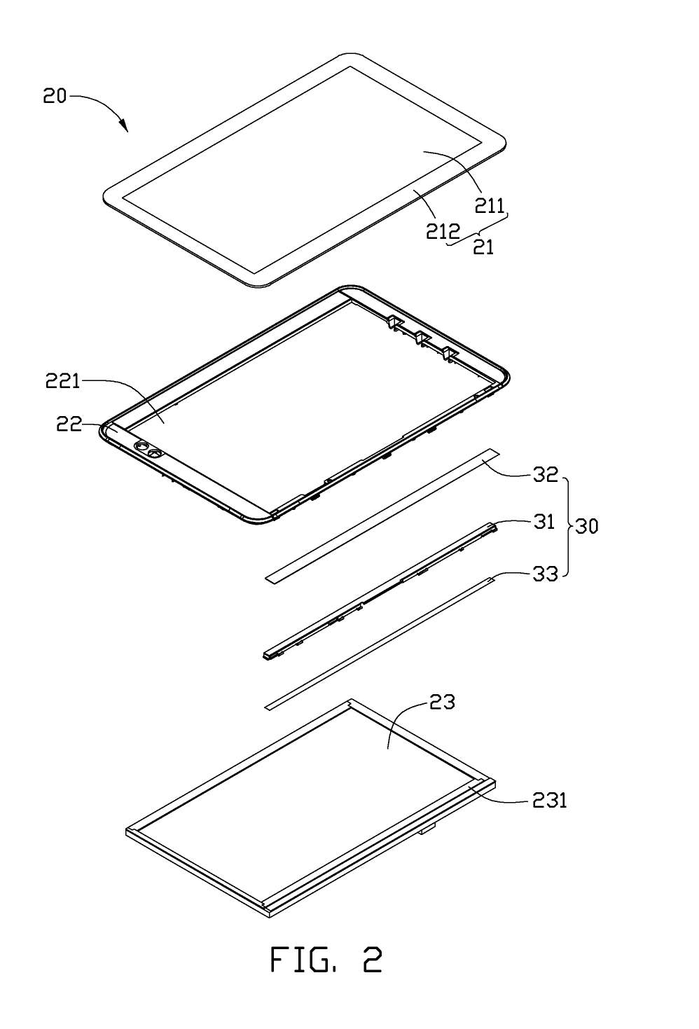

Referring to FIG. 2, the touch sensitive display module 20 includes a touch panel 21, a front frame 22, a display panel 23 and a securing structure 30 to secure the touch panel 21, the front frame 22 and the display panel 23 together.

The front frame 22 includes a hollow space 221 that allows the display panel 23 to be exposed. A number of foam pieces 231 are set around the edges of the display panel 23, which can prevent contaminants from entering into the display panel 23. The front frame 22 further includes a supporting surface, and the touch panel 21 rests on the supporting surface of front frame 22 and the display panel 23. The touch panel 21 includes a transparent area 211 and an opaque rim portion 212 surrounding the transparent area 211.

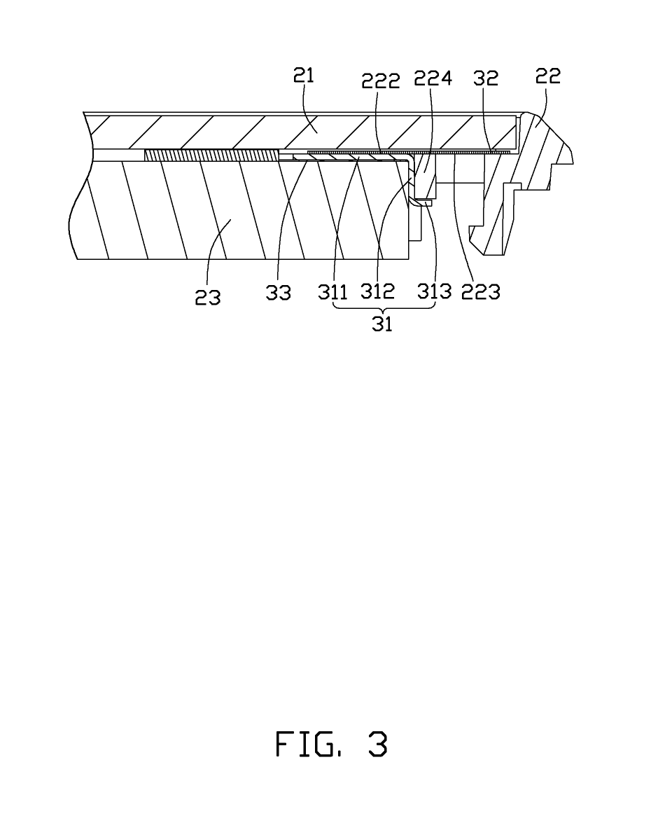

The securing structure 30 includes an elongated securing member 31 and double-faced adhesive tape 32, 33. Referring also to FIG. 3, in the embodiment, the securing member 31 includes an elongated tab 311, a sidewall 312 depending substantially perpendicularly from one edge of the elongated tab 311, and an angled portion 313 protruding substantially perpendicularly from one edge of the sidewall 312 and extending away from the elongated tab 311. The elongated tab 311 is sandwiched between the upper surface of the display panel 23 and the touch panel 21, the sidewall 312 is sandwiched between a limiting element 224 of the front frame 22 and the sidewall of the display panel 23, and the limiting element 224 rests on the angled portion 313. The securing member 31 and the front frame 22 cooperate to prevent the display panel 23 from moving upward. As a result, the display panel 23 cannot push the touch panel 21, and the problems that occur in some electronic devices in the related art, will not occur in the electronic device 100.

In the embodiment, the upper surface of the elongated tab 311 of the securing member 31 is substantially coplanar with an supporting surface 223 of the front frame 22, the upper surface of the elongated tab 311 and the upper surface of the front frame 22 cooperatively form a flat supporting face 222 where the edge of the touch panel 21 rests.

The double-faced adhesive tape 32 is used to adhere the edge of the lower surface of the touch panel 21 to the flat supporting surface 222, and the double-faced adhesive tape 33 is used to adhere the elongated tab 311 of the securing member 31 to the edge of the upper surface of the display panel 23. With such a structure, the securing member 31 increases the contact area between the touch panel 21 and the front frame 22 and the display panel 23, which enables the touch panel 21, the front frame 22 and the display panel 23 to be secured firmly together.

In assembly, first, adhering one side of the double-faced adhesive tape 33 to the edge of the upper surface of the display panel 23. Adhering the elongated tab 311 of the securing member 31 to the other side of the adhesive tape 33. Pressing the sidewall 312 of the securing member 31 firmly against the sidewall of the display panel 23. The securing member 31 is then secured to the display panel 23 by the adhesive tape 33. Then, assembling the display panel 23 and the securing member 31 to the hollow space 221 of the front frame 22, with the limiting element 224 of the front frame 22 resting on the angled portion 313 of the securing member 31. The upper surfaces of the elongated tab 311 of the securing member 31 is now substantially flush with the upper surface of the front frame 22, which defines the flat supporting surface 222. Finally, adhering one side of the adhesive tape 32 to the flat supporting surface 222, and adhering the edge of the lower surface of the touch panel 21 to the other side of the adhesive tape 32.

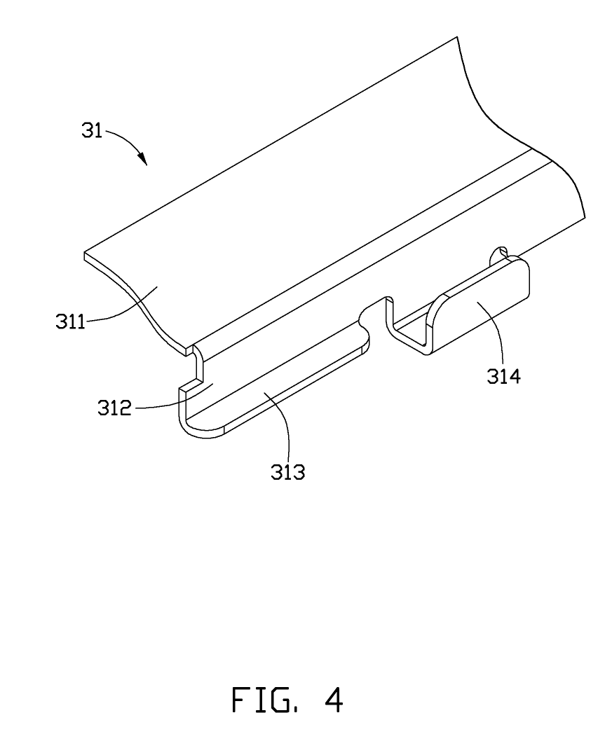

Referring to FIG. 4, in one embodiment, the angled portion 313 of the securing member 31 includes a number of spaced sections extending perpendicularly from the sidewall 312. In another embodiment, a number of hooks 314 extend from the angled portion 313, and are used to hook the bottom of the front frame 22.

Moreover, it is to be understood that the disclosure may be embodied in other forms without departing from the spirit thereof. Thus, the present examples and embodiments are to be considered in all respects as illustrative and not restrictive, and the disclosure is not to be limited to the details given herein.

What is claimed is:

1. A touch sensitive display module comprising:
a display panel;
a front frame comprising a supporting surface and a limiting element;
a touch panel resting on the supporting surface of the front frame; and
a securing structure configured to secure the touch panel, the front frame and the display panel together, the securing structure comprising:
an elongated securing member comprising:
an elongated tab resting on an upper surface of the display panel, an upper surface of the elongated tab being coplanar with an upper surface of the front frame, the upper surface of the elongated tab and the upper surface of the front frame cooperatively forming a flat supporting surface where the touch panel rests;
a sidewall depending from the elongated tab, the sidewall sandwiched between the limiting element of the front frame and a sidewall of the display panel; and
an angled portion protruding from the sidewall of the securing member, and extending away from the elongated tab, the limiting element of the front frame resting on the angled portion; and
a first double-faced adhesive tape configured to adhere the touch panel to the flat supporting surface; and
a second double-faced adhesive tape configured to adhere the elongated tab to the upper surface of the display panel.

2. The touch sensitive display module of claim 1, wherein a number of hooks extend from the angled portion, and are configured to hook a bottom of the front frame.

3. The touch sensitive display module of claim 1, wherein the angled portion includes a plurality of spaced sections extending perpendicularly from the sidewall of the securing member.

4. The touch sensitive display module of claim 3, wherein a number of hooks extend from the angled portion, and are configured to hook a bottom of the front frame.

5. An electronic device comprising:
a housing; and
a touch sensitive display module housed in the housing, the touch sensitive display module comprising:
a display panel;
a front frame comprising a supporting surface and a limiting element;
a touch panel resting on the supporting surface of the front frame;
an elongated securing member comprising:
an elongated tab sandwiched between the display panel and the touch panel;
a sidewall depending from one edge of the elongated tab, the sidewall sandwiched between the limiting element of the front frame and the display panel; and
an angled portion protruding from one edge of the sidewall of the securing member, and extending away from the elongated tab, the limiting element of the front frame resting on the angled portion; and
a first double-faced adhesive tape configured to adhere the touch panel to the supporting surface of the front frame and the elongated tab; and
a second double-faced adhesive tape configured to adhere the elongated tab to the display panel.

6. The electronic device of claim 5, wherein a number of hooks extend from the angled portion, and are configured to hook a bottom of the front frame.

7. The electronic device of claim 5, wherein the angled portion includes a plurality of spaced sections extending perpendicularly from the sidewall of the securing member.

8. The electronic device of claim 7, wherein a number of hooks extend from the angled portion, and are configured to hook a bottom of the front frame.
